(19) United States
(12) Patent Application Publication
(10) Pub. No.: US 2008/0262924 A1
(43) Pub. Date: Oct. 23, 2008

(54) Method and system to promote actions such as environmental and charitable actions

(76) Inventor: Sebastien Leonard, Montreal (CA)

Correspondence Address: VENABLE LLP, P.O. BOX 34385, WASHINGTON, DC, 20043-9998, US

(21) Appl. No.: 12/078,720

(22) Filed: Apr. 3, 2008

Related U.S. Application Data
(60) Provisional application No. 60/909,741, filed on Apr. 3, 2007.

(51) Int. Cl. G06Q 30/00; G06Q 10/00; G06Q 50/00

(52) U.S. Cl. 705/14; 705/500; 705/1

(57) ABSTRACT

The present method and system allows promoting a first action by a first entity, such as a transactional action. The transactional action occurs between the first entity and a second entity, which both can be for example in the form of an individual, a group of person, a company or a charitable society, whereby the first entity for example buys, borrows or acquires a products or service from the entity. In response to this transaction, the second entity agrees to perform a second action, which can take many forms such as an environmental action, a third action towards a third entity, etc. This second action is personalized by associating it to any party including at least one of the first and second entities and a third party. The second action is, for example, in the form of the offsetting of the pollution created by the first party following and related to the transactional action with the second party. The present method and system provides an incentive for the first entity to perform the transactional action.

### FIELD

The present invention relates to methods and systems to promote business and charitable activities. The present invention also relates to a method and system which allows promoting environmental actions such as lowering the emission of CO₂ associated to specific human activities.

### BACKGROUND

From the second half of the last century through these days, there has been a steady increase of pollutants produced by human activities found in the environment. This has cause a huge impact on the Earth's climate and environmental conditions.

With the raise of public consciousness towards a cleaner environment, natural and artificial means have been proposed for partially or completely neutralizing the emissions of pollution, and even to attributing it to individuals, companies or other entities.

The presently most common pollutant offsetting methods can be separated in two main categories: organizations contributing to offsetting an amount of pollutant in exchange of monetary contributions; and retailers, service providers or organisms offsetting a determined amount of pollutant caused by one of its product bought by a consumer.

A more specific example of the second method is car manufacturers being responsible to planting trees to offset at least part of the CO₂ emission of one of its car after its acquisition by a consumer.

However, pollutant offsetting methods or more generally environmental actions from the prior art either require interested individuals or companies to contribute to the environmental action on their own initiative or cause the good publicity following the beneficial action to be attributed to the promoter of a business promotion that includes such an environmental action, in both case yielding limited incentives to interested parties to contribute thereto.

### BRIEF DESCRIPTION OF THE DRAWINGS

In the appended drawings:

FIG. 1 is a flowchart of a method for promoting an environmental action according to an illustrative embodiment of the present invention;

FIG. 2 is a schematic view of a system for promoting an environmental action according to an illustrative embodiment of the present invention; and

FIG. 3 is a schematic view of a computer screen displaying a map of including a stand of trees personalized to an individual as part of the method from FIG. 1 and of the system From FIG. 2.

### DETAILED DESCRIPTION

More specifically, in accordance with a first aspect of the present invention, there is provided a system to promote a first action by a first entity comprising:
means to allow a second entity to acknowledge the first action after the first action being performed the first entity; and
means to personalize a second action performed by the second entity in response to the first action.

According to a second aspect of the present invention, there is provided a method to promote a first action by a first entity comprising:
the second entity performing a second; and
the second entity personalizing the second action in response to the first action by the first entity.

It is to be noted that the expression “performing an action” is to be construed herein broadly as including also the indirectly performing the action, for example via a subsidiary.

According to a more specific aspect of the present invention, a transactional action is promoted between two entities, which both can be for example in the form of an individual, a group of person, a company or a charitable society, whereby a first entity, for example, buys, borrows or acquires a products or service from a second entity. In response to this transaction, the second entity agrees to perform a second action, which can take many forms such as, without limitations, an environmental action, a third action towards a third entity, etc. This second action is personalized by associating it to any party including at least one of the first and second entities and a third party.

According to a further illustrative aspect of the present invention, the second action can be in the form of the offsetting of the pollution created by the first party following and related to the transactional action with the second party.

The present method and system provides an additional incentive to the first entity performing the transactional action.

Other objects, advantages and features of the present invention will become more apparent upon reading the following non restrictive description of illustrated embodiments thereof, given by way of example only with reference to the accompanying drawings.

In the following description, similar features in the drawings have been given similar reference numerals, and in order not to weigh down the figures, some elements are not referred to in some figures if they were already identified in a precedent figure.

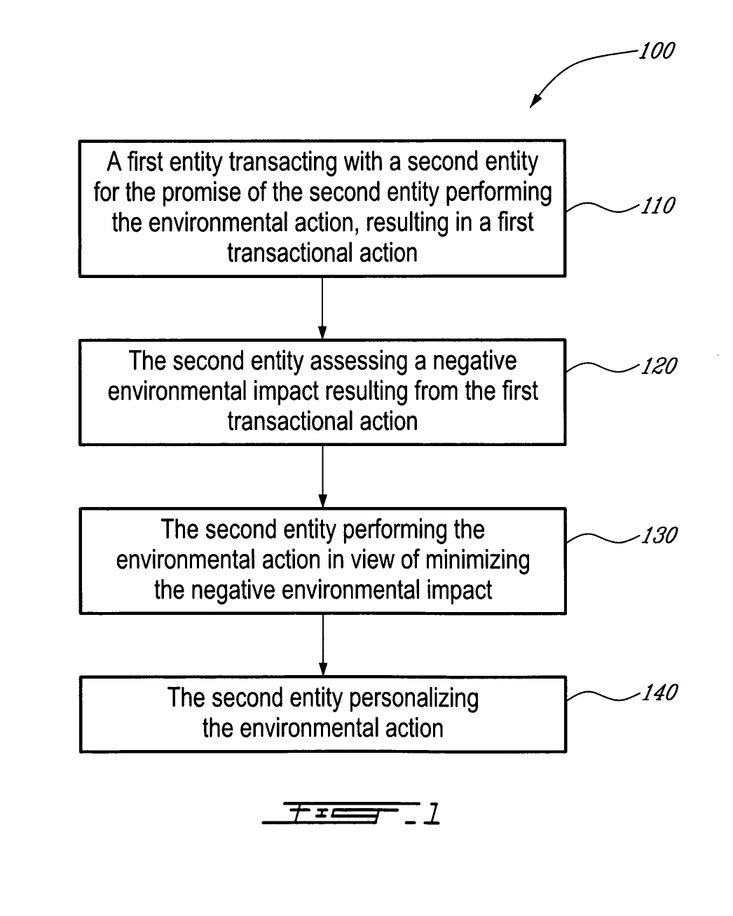

A method 100 to promote an environmental action according to a first illustrative embodiment of the present invention will now be described with reference to FIG. 1.

The method 100 comprises the following steps:

110—a first entity transacting with a second entity for the promise of the second entity performing the environmental action, resulting in a first transactional action;

120—the second entity assessing a negative environmental impact resulting from the first transactional action;

130—the second entity performing the environmental action in view of minimizing the negative environmental impact; and

140—the second entity personalizing the environmental action.

Each of these steps will now be described in more detail with reference to more specific illustrative embodiments of the present invention.

According to the first illustrative embodiment, the method 100 concerns promoting the offsetting of the quantity of CO₂ produced by the owner of a motor vehicle 18 by the limited use of the vehicle.

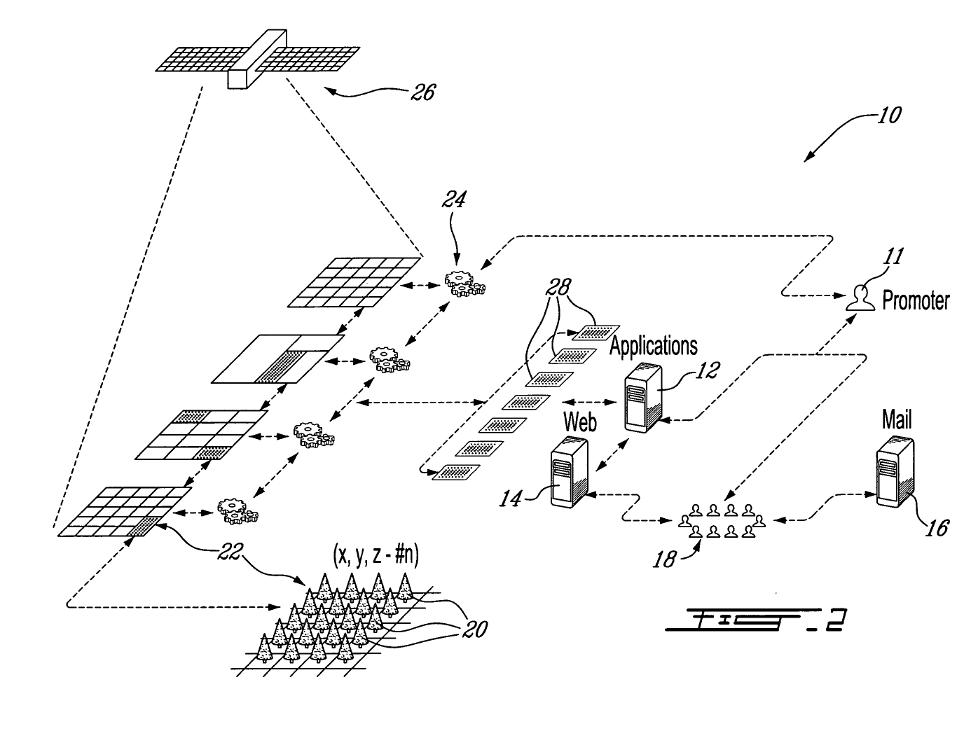

Prior to step 110, in step 102, the second entity, which is in the form of a car company 11 (see FIG. 2) advertizes the offsetting of the approximate quantity of CO₂ emitted by the use of a specific brand of its cars during a predetermined number of kilometers. This advertizing can be performed via means and methods known in the marketing art, including television spots, magazine adds, or banner or more generally information on a web site (not shown).

In step 110, the car company 11 sells or rent a car from the specific brand to the first entity which is in the form of a consumer 18, with the promise of offsetting the approximate quantity of CO₂ emitted by its use during the predetermined number of kilometers.

In step 120, the car company 11 assesses the average quantity of CO₂ emitted by the use of the car over the predetermined number of kilometers. Step 120 can of course be performed prior to the transaction in step 110. A quantified result of this assessment can also be used in the advertizing step 102.

In step 130, the car company 11 plants a predetermined quantity of vegetations such as trees 20 at a specific location 22, which allows offsetting the average quantity of CO₂.

Step 130 includes the sub-step 132 of the further assessment of the quantity of vegetation 20 to be planted to offset the calculated quantity of CO₂. Charts from the public domain can also be used to assess the quantity of vegetation 20.

Finally, in step 140, using for example referencing tools, the car company provides tangible means to personalize the trees 20 resulting from the offsetting action to the consumer 18. More specifically, the trees 20 are visually associated to the promoter, the consumer and/or to a third party selected following a further secondary step of the method 100.

The tangible identification means provided in step 140 allows associating the offsetting action, for example, to any one of the entities 11 or 18 directly or indirectly responsible thereto.

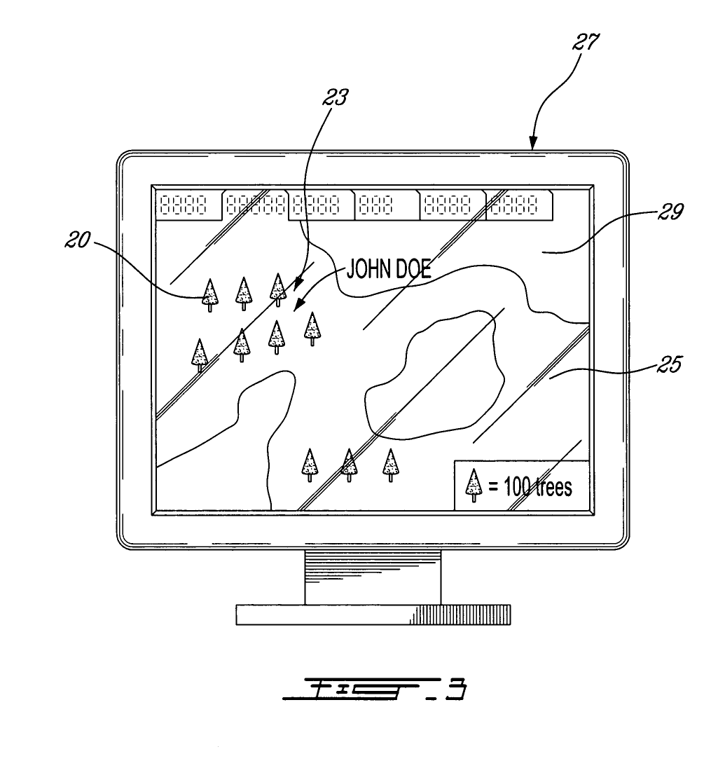

As will be described hereinbelow in more detail with reference to FIG. 3, the tangible identification means is in the form of a visual representation 23 of the trees 20 in its geographical context on a web page 25.

Other examples of tangible representation means will be provided hereinbelow.

As a more specific illustrative embodiment, it can be determined that the car consumes approximately 1000 liters of fuel to cover 20,000 km. As a result of combustion, such a car emits approximately five tons of CO₂ into the atmosphere. It can be assessed that these emissions are offset by planting five hundred trees 20 on a tract of land 22, considering that over an eighty years period, the trees 20 would contribute eliminating the five tons of CO₂ emitted. The area occupied by the trees 20 is attributed to the consumer acquiring the vehicle. According to a further illustrative embodiment, the consumer chooses among a provided list of sites the location where the trees 20 will be planted.

As will now become more apparent, the method 100 promotes both the positive environmental action and the acquisition of cars by consumers 18.

The method 100 is not limited to the first entity, the consumer, transacting with the second entity, the car manufacturer, regarding a single first action or the second entity performing a single second action in view of minimizing the environmental impact of the first action.

For example, with reference to the previous example, the consumer 18 might have for example to combine the acquisition of the vehicle to participating and winning a contest for the second entity to perform the second action. Similarly, in addition to planting vegetations, the car company 11 might have to install a further anti-polluting system on the vehicle at the end of the predetermined kilometers.

More generally, the offsetting operation can be conducted with the aim of developing the first action and promoting the results of various actions, environmental or not, taken and associating them with the participants 18 or to any other first entity, with the ultimate goal of ensuring an ongoing exchange relation between the first and second entities 18 and 11.

Other more specific illustrative embodiment of the method 100 will be presented furtherin.

A system 10 to promote an environmental action according to a second illustrated embodiment of the present invention will now be described with reference to FIG. 2. The system 10 is configured to embody the method 100.

As will be described hereinbelow in more detail, the computer system 10 allows personalizing an installation 22, located in spaces, by associating information relative to a selected entity to this installation 22. The installation 22 has been selected and/or created for its capacity to offset the pollution created by a participant action. The installation 22 with the selected entity 18 are associated and represented on a web page using, for example, a web application.

The system 10 includes an application server 12, a web server 14 coupled to the application server 12 and a communication server in the form of a mail server 16 also coupled to the application server 12.

The system 10 allows promoting the offsetting of the quantity of CO₂ produced by the owner 18 of a motor vehicle (not shown) by the limited use of the vehicle. The vehicle as been acquired from a car company 11 which acts as the promoter of the CO₂ offsetting.

As will become more apparent upon reading the following description, the application server 12 and web server 14 allow the promoter 11 to acknowledge the acquisition of the car by the consumer 18 and the personalization of the environmental action. The application server 12 acts as a general controller that coordinates and manages the operation of the promotion and data related to.

The application server 12 allows receiving data indicative of the first action having been performed by the first entity 18. According to the second illustrative embodiment, the application server 12 allows receiving data indicative of the consumer having acquired a car from the car company.

These and other more specific features of the system 10 will now be described in more detail.

The application server 12 is programmed with applications to manage information pertaining to the consumers 18 participating in the promotion of the environmental action, which will sometimes be referred to herein simply as the “promotion”.

The offsetting results from the planting of trees 20 or other vegetation by the promoter 11 on stands 22 whose coordinates are referenced by conventional referencing tools 26.

More specifically, each stand 22 is characterized by an area referenced using global positioning identification. Each stand 22 is further associated to legal rights that can be further associated to a third party. It is physically marked and defined according to conventional scientific and geographical criteria.

The stands 22 result from the transformation of rough areas 28. The transformation 24 is performed accordingly to the type of vegetations to plant using methods and process known in the art.

As will be described hereinbelow, each referenced stand 22 and/or tree 20 can be defined and associated to a participant, the promoter 11 or a third party, in a database coupled or part of the application server 12. Each offsetting component 20 can further be characterized in various ways and arbitrarily associated to more than one stand 22. The characteristics used to characterize the tree 20 or stands 22 can also be associated and linked in the database to a designated entity.

These characteristics of the trees 20 or stand 22 include for example the provider of the trees 20, the species of the trees 20, the contractor responsible for the plantation, the date of the plantation, projections of potential influence on the environment based on scientific assessments, etc.

The application server 12 and/or web server 14 allow the promoter 11 to acknowledge the acquisition of the car by the participant 18 by including computer applications or tools allowing access for the participants 18 to relevant information.

According to the second illustrative embodiment, the web applications is coupled to a database including information relative to the participants 18 and to the business transactions through which each participant 18 acquired its vehicle.

This information relative to the acquisition of the vehicle includes any one of the following: contract number, information on the contract, coordinates or any other information relative to the participant 18, information relative to the car dealer, and any specific information or request from any one of the promoter 11 or participant 18 concerning the offsetting action by the promoter 11.

The web server 14 is programmed with instructions for hosting a web site remotely accessible by the participants 18 which allow the participants 18 to visualize a photographic or graphical representation of a map 25 showing the trees 20 planted in order to achieve the offsetting action (see on FIG. 3). The map 25 further allows visualizing either one or both of the promoter's or participant's name or identification 29. This allows personalizing the offsetting action performed by the promoter 11 in response to the participant 18 acquiring the vehicle.

More generally, the web site acts as a gateway to the environmental promotion set up by the promoter 11 and introduces information related thereto, including introducing the various activities and elements as described hereinabove.

The web server 14 is further program with web pages allowing the participants to access information relatively to the offsetting action.

The application server 12 further includes a plantation management application to determine optimization actions to be performed on the trees 20 or stands 22 to yield the CO₂ offsetting objectives promised by the promoter 11 in return for the acquisition of the car by the participants 18. The web site hosted on the web server is of course programmed so as to allow accessing and displaying any information relative to the implantation and management of the offsetting action. This information is selected by the promoter 11 and the application or web server 12-14 can be program to restrict access to this information to the participants 18.

The application server 12 also includes applications for managing activities and information relating to the stands 22 and vegetation 20 and more generally to any data related to the promotion of the environmental action. These activity managing applications allow computing the biomass amount required to offset a predetermined quantity of CO₂.

Also, the application server 12 or any other server coupled thereto includes applications linked to a database platform, implemented on the server 12 via conventional tools, which manages the status of participants 18 in the business promotion.

Participants' profiles are managed for example according to the extent of their contribution, their status as a participant in the process, their degree of involvement in the various proposals or to any other criteria as defined according to the promotion.

A document manager application is further provided to manage and forward literature to the each member according to its status, to a specific action or to the results of an action directly or indirectly part of the promotion.

More specifically, the application server 12 includes a platform management application where activities in the promotion are managed.

The activities include i) the first action completed by the participant 18 which is, according to the second embodiment, acquiring the car, and ii) the second action performed by the promoter 11, for example plating trees 20 so as to offset the CO₂ emission of the participant 18 produced while using the acquired car. The application server 12 can be programmed so as to manage other similar activities part of the method 100. For example, the promoter 11 may be involved simultaneously in more than one promotion.

The platform management application further allows managing for example, without limitations:
land operations 24 based on criteria for each activity part of the promotion;
any characteristics and features of the managed sites 22, including physical and chemical features; and
the correspondence between each participant 18 and a precise stand 22

A plurality of platform management applications can also be provided to perform the above-mentioned functionalities.

Conventional database components are managed by the application server 12 which describes and compiles elements that can be referenced and included as manageable items in the promotion, such as:
1. physical elements, including biological and natural elements, such as trees or others,
2. legal elements, including contracts, disclaimers, etc.;
3. participants identifying elements, including their name, coordinates, preferences;
4. analytical and classifying elements allowing for example to profile participants and action-related data;
5. referencing/positioning elements 26;
6. projections for potential impacts of the environmental actions; and
7. political elements when the promotion involves a political campaign or a fund-raising campaign.

The web server 14 hosts and links conventional data management applications and acts as a host for the web interfaces which manage and display the web pages.

The website 14 includes pages including graphical user interface elements, for example for:

a. presenting the environmental promotion;

b. explaining the various opportunities offered by the environmental promotion;

c describing the various ways to participate and presenting all implementation of the promotion and other promotions, and offering memberships and participant fidelity elements, including points in an associate program or promotion, money, rebates on products including those offered by the promoter 11, etc.;

d. evaluating the participants' emissions and any other impacts they have on the environment (CO₂, electricity consumption, pollutant emissions, material consumption in a given time period), related or not to the car acquired from the promoter 11;

e. registering participants 18 in the promotion, including referencing an access code provided during the acquisition of the car to data in the databases, gathering information on the participant 18 prior to the participant 18 doing the first action, the participant 18 providing coordinates of a third entity to be associated to the second action, etc.;

f. providing links to similar or related sites;

g. personalizing the second action, including for example displaying printable statements and/or graphical representation of the stand of trees or of any other pollutant compensator(s), with geographical coordinates provided by the positioning systems 26 with the name of a personalizing entity. The personalizing entity, can be the promoter 11, the participant 18 or any other person or company, etc. selected for example by the promoter 11 or by the participant 18;

h. educational activities related to the environmental promotion or to similar activities;

i. promoting an “action challenge” by inviting people to join the ranks of one or a plurality of positive action environmental movements which result for example in an action such as the second action from the promoter 11;

j. illustrating the progress and results achieved by the promotion and/or encouraging a sufficient number of people to participate in the promotion by providing information including for example statistics on the number of trees planted, the quantity of CO₂ offset, etc. or on any other element characterizing the promotion;

k. providing search tool for information relating to the promotion;

l. visual references and cross-references of environmental actions taken through the promotion;

m. the distribution of offers of products and services related to the promotion;

n. registering participants 18 in an information network managed as part of the promotion to receive messages in various forms, including allowing the participants to select transmission and communication preferences with the promotion platform (personal digital assistant (PDA), Web, landline telephone, cell phone, etc.). The information system will be described hereinbelow in more detail;

o. participants 18 to promote the second action by the promoter 11 using for example an email platform;

p. including personalized information about participants 18 further allowing for this participants to invite a targeted group of individuals to join in a concerted environmental effort;

q. presenting and/or advertizing different partners and organizations that support the business process as participants or as third parties;

r. allowing participants 18 to gain, manage and exchange credits that may be acquired by participating in secondary promotions; and

s. allowing the participants 18 to be informed through the information system of associated projects and promotion.

These and other features can be provided on combined or individual web pages and can be implemented through the use of well-known graphical user interface means, including without limitations, pop-up and drop-down menus, hyperlinks, audio and video web objects, etc.

The web pages are managed and linked by one or more databases (not shown) and referencing systems and methods. This allows the web pages implemented in the web server 14 to be linked to remote public databases (not shown) allowing the content generated by these links to be forwarded by way of conventional distribution and communication methods thereby furthering the development, management and operation of the promotion.

The communication server 16 is provided with a conventional mail client service that handles the previously mentioned communication aspect of the promotion. The communication server 16 further allows for managing cross-platform, external, public and private communications related to the management of different aspects of the promotion.

The types of distributed messages which can be implemented and handled by the communication server concerns any one or a combination of the following: the promotion, development of further businesses which can be seen as secondary since they do not concern directly the promotion, dissemination of information concerning the promotion, the promoters 11 and/or the participants 18, management of participant's relations with the promoter 11 or with other past, present and potential participants 18, etc.

A communication development application and more generally the email service are also used in:
soliciting potential participants (not shown) in the promotion;
distributing information on the promotion to participants 18 or others;
the promoter 11 maintaining relations with participants 18;
promoting, distributing and managing transactions from the web site for the distribution of offers of products and services related to the business process; and promoting achievements of the promotion and more specifically for example its pollutant offsetting achievements.

The application server 12 is further programmed with an application for distributing and transmitting messages through the mail server 16 informing a participant 18 of its proximity to a stand 22 associated him through the promotion, for example by linking referencing bases to profile and/or contribution of the participant. For example, a text message can be sent by the promoter 11 or else to the participant's cell phone to indicate that the person is in the vicinity of a project to which he is associated.

The communication server 16 is further configures for forwarding and receiving message to the participants 18 in a format that is easily readable for one or a plurality of communication devices registered by each participant 18, including cell phones, PDAs, fax machines, etc. (not shown).

The system 10 can further include a customer relationship management (CRM) server (not shown) including a CRM application for managing relational aspects among existing and potential participants in various programs including the promotion and promoter's or tiers offers. The CRM application can alternatively be implemented on the application server 12 or on the mail server 14.

In addition to the system 10 being configured to allow communication among the participants 18, promoter 11 and third parties, the system 10, and more specifically the application server 12 further includes applications or is coupled to remote computer systems or tools (not shown) for managing the rough area 28 and resulting stands 22 with trees 20.

More specifically, the managing operations include indexing the stands 22 and trees 20 and associating them to participants 18, collecting information relative thereto. More specifically, the managing operations with regards to the rough surfaces 28, includes coordinating their transforming into stands 22, coordinating works relative thereto, quantifying the costs of the transforming works, managing bids, etc.

The information relative to the stands 22 and trees 20 relates for example to their geo-positioning, dimensions, offsetting capabilities over time, etc.

The remote computer systems or tools for managing the rough surfaces 28, stands 22 and trees 20 and/or the application server 12 are configured for communication with the referencing systems 26. For that purpose, a descriptive characterizing process including a set of physical, technological, geographical, mathematical, biological data related to the stands 22 or tree 20 can be used for the characterization and assigning of the lands 28, stands 22 and/or trees 20.

Conventional referencing tools, including for example global positioning systems (GPS) 26, are used for locating in space and time the elements 20 used to offset the CO₂ emission of the participants 18. The referencing can relates to the trees 20 or be more generally limited to stands 22.

The referencing tools includes differential global positioning system (DGPS) or GPS stations (not shown), each mounted to or adjacent the trees 20 or stands 22, GPS satellites 26 for detecting the position of each stations within a predetermined precision and network devices (not shown) for transmitting the detected positions to the application server 12.

Alternatively or additionally to the GPS stations, the system can include one or a plurality of portable computer stations coupled to the application server 12 to compile data used in referencing the offsetting elements 20-22 and associating them to predetermined participants 18. After their referencing and association to participants 18, these data can be used to provide a graphical or text description and representation of the offsetting element in a geographical context, providing a proof of the offsetting action via a web page on the web server 14. The communication server 16 further allows means to communicate the proof to the participants 18 via the communication devices registered by the participant. An e-mail including the graphical representation or a link to the specific web page, a SMS message, or a facsimile can be used for example. Since these means an referencing tools are believed to be well-known in the art, they will not be detailed furtherin.

With reference to FIG. 2, the following summarizes a sample cycle resulting from the application of the method 100 using the system 10 for promoting an environmental action according to the second illustrative embodiment of the present invention.

A quantity of tons of CO₂ (y) is rejected in the environment over a period of time (t1) by the use of a motor vehicle acquired by a participant 18 from a car manufacturer, which acts as the promoter 11. It is computed that this quantity of CO₂ (y) may be captured by a number (n) of trees 20 which naturally absorb CO₂ through the process of photosynthesis and can also be associated with represent a quantity of biomass (b1), yielding a capture potential (p) over the period of time (t1).

The number (n) of trees 20 is sold under an emphyteutic lease or symbolically to one of the participant 18 as a result of its acquisition of the vehicle. This number (n) of trees 20 covers a land area of (sl) m² or (vl) m³ to which a point in space whose coordinates x, y, z (c) can be attributed and determined using GPS technology for example.

The satellite coordinates (c) associated to the number (n) of trees 20 can then be associated to a selected entity with a computer system linked to a collection of images, photos, maps, registers or other services allowing for the localization representation and personalization of the number (n) of trees 20.

Characterizing data associated to the trees 20 are contained in a database and associated to a selected entity, which can be the promoter 11, the participant 18 or any other third party as part of the personalization process. These data can be used in creating a score for CO₂ capture potential or any other indication or rating of the environmental action. These data can be represented and sold as units of different quantities, which can be offered in the form of a product or sold in whole or in part for a given period of time. Therefore, the attribution of trees 20 with CO₂ capture potential is based on a specific quantity of biomass, which can be associated in various ways, including by the participant who has thereby arranged to offset his CO₂ emissions.

The personalization of the attribution of trees 20 by associated these trees 20 to the selected entity allows the environmental action to be publicized using various methods of communication and represented in different forms. Moreover, since this publicity is beneficial, the method 100 allows further promoting the acquisition of car from the promoter 11 in addition to the promotion of an environmental action.

The web site hosted by the web server 14 further allows for searching, locating, representing and defining the stand 22 and its physical location and defining it by association with defining criteria.

Even though the system 10 has been described as including a single application server 12 with a web server 14 and a communication server 16, the number and purposes of each server may vary in order to provide the above-described functionalities. The different servers can be coupled to one another via a conventional computer network, which can be wired or wireless.

Since server connectivity and functionalities and network operation are believed to be well-known in the art, and fro concision purposes, they will not be described herein in more detail.

A system for promoting a first action from a first entity according to the present invention is not limited to include computers or electronic devices to personalize a second action resulting from the completion of a first action. Any advertizing or displaying tool can be used for that purpose.

The system 10 may additionally or alternatively includes communication devices communication and/or interaction with participants equipped with communication devices such as without limitations: a portable phone, a personal computer, a web-enabled device, etc.

For example, a contextual picture in a periodical or in any publication of the result of a second action or of the actual second action being performed with, for example, an accompanying text can be used to associate the second action to any entity so as to personalize the second action.

Methods for promoting an environmental action according to further illustrative embodiments will now be described. Since these methods are similar to the method 100 according to the first illustrative embodiment, and for concision purposes, only the differences between each of these methods and the method 100 will now be described.

According to a third illustrative embodiment of the present invention, the method includes the financing of the partial or total deployment of solar panels defining an active surface for the production of electricity as an offsetting alternative to the volumes of a contaminant produced following the operation of a thermal power plant. According to this second illustrative embodiment, the operator of the power plant is responsible for the installation of the solar panels, in response to its clients consuming electricity produced by the power plant. The pollutant produced by the power plant on pro rata of the consumption of the client is therefore not offset, but the method to promote an environmental action according to this third illustrative embodiment forces the power plant operator to produce greener electricity. The production of greener electricity is publicly associated to the promoter, the client or a third party selected by the promoter or the client which then acquires public recognition for the beneficial environmental action.

A system (not shown) is provided by the operator of the power plant which allows visualizing a representation or satellite picture of each of the solar panels with text identifying the entity associated thereto. The solar panels, whose coordinates are precisely known using a GPS system, are further associated with the issuing of carbon credits that can be traded on a well-known dedicated market.

The method and system according to the third illustrative embodiment allows for the association of equivalent emissions produced by the use of a source that emits contaminants, pollutants and/or substances into the environment with alternative sources deemed to produce less pollution and fewer emissions and which can be located using their coordinates. The client's participation in the promotion is promoted by providing a visual association between a selected entity and solar panels and therefore to the beneficial environmental action. This approach is supported by a system to promote the participation of individuals in this action including means of communication which allow reinforcing the value of the impact of the clients' participation in addition to the positive environmental action. The method can further include a marketing and communication campaign aimed at intensifying actions taken with the client. The intensifying actions may include managing and displaying, for example on a web site, a progress chart or any progress indicator means indicative of the progress of the implementation of the solar panels or of the reduction of emission relative to predetermined targets.

A method for promoting an environmental action according to a fourth illustrated embodiment of the present invention comprises the sale of a given wetland surface. This surface representing a quantifiable biological component to be conserved, it is offered in exchange for plots of land to be developed in a way that would result in their biological alteration. Both the plots of land and the wetland surface could be referenced spatially, put into perspective in various ways and promoted through an advertising campaign. The conserved wetland is associated to an entity, which can be the promoter or the clients thereof which acquire the plots of land. The association is publicized, resulting in the personalization of the wetland.

According to a fifth illustrative embodiment of a method for promoting an environmental action according to the present invention, the referencing and identification of the natural potential and volume occupied by a plot of land in a natural setting unaltered by human activity is assigned under an emphyteutic lease to contribute to conserving this natural area in time. It can be lend to third parties and associated thereto according to different criteria, and promoted as necessary using a system such as the system 10. According to this specific embodiment, and referencing to FIG. 1, the tenant is the first entity, the promoter is the second entity, the first transactional action is the emphyteutic lease, the environmental impact by the second entity is in the form of the promoter preparing and unaltering the plot of land, and the personalization of this environmental action is in the form of the promoter allowing the tenant to gain publicity by sub-lending and associating to third parties his portion of the plot of land.

According to a sixth illustrative embodiment of the present invention, greeting cards, each associated with a specific stand of trees planted for the occasion, are sold by a merchant who acts as the promoter of the environmental action. The stand of trees is in a precise location with unique and precise coordinates recorded in a database and is personalized by publicly associated it according to various criteria with the card sender or receiver.

According to a further illustrative embodiment (not shown), a method and system for the promotion of an environmental action according to the present invention allows the following: in addition to action by the promoter being attributed to the participants, himself or a third party, any individual, company or society can be informed, through the system 10 of the positive impact the environmental action.

It is to be noted that CO₂ has been used only as an illustrative example of a pollutant whose offsetting can be promoted by a method according to the present invention. The present invention can be used to promote the offsetting of any other source of pollution for air, water or else, such, a without limitations, methane, NO, SO₄, fertilizer, cyanobacteria, hydrocarbon, and any substance or molecule which un-stabilizes the equilibrium of a biological or chemical system.

Also a method to promote an action by a first entity according to the present invention is not limited to including the action by the first entity being in the form of the acquisition of a product or service from the second entity. This first action by the first entity, which results in the second entity performing a second action, can be in the form of any action performed by the first entity implying or not the second entity. For example, this first action by the first entity can be an environmental action, a polluting action, a transaction with a third entity, a charitable action, etc.

Similarly the second action by the second entity in response to the first action is not limited to an action aiming to offset a polluting action by the first entity. This second action can be an action, environmental or charitable or not, towards the second entity, itself, or towards a third party.

The second action can also be attributed to any party. The personalization of this second action can take any form, including the printing of a receipt and associating publicly the second action to a party using any type of media such as printing media, television spot or else, web sites, phone messages, facsimiles, etc.

According to the present invention, it is not required that the result of the second action be referenced so as to be physically associated to the party associated thereto.

It is to be noted that a method according to the present invention includes the personalization of a second action by a second entity after a first action has been performed by a first entity notwithstanding of the performing order between the first and second actions.

Also, a computer system to promote a first action by a first entity according to the present invention is not limited to the components illustrated in FIG. 1 and listed hereinabove. It can take other form allowing implementing a method for promoting a first action by a first entity according to the present invention, for example as described hereinabove.

For example, the functionalities of the system described hereinabove can be implemented on a single server or deployed on a different number of servers.

It is to be understood that the invention is not limited in its application to the details of construction and parts illustrated in the accompanying drawings and described hereinabove. The invention is capable of other embodiments and of being practiced in various ways.

It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A method to promote a first action by a first entity comprising:
a second entity performing a second action; and
the second entity personalizing the second action in response to the first action by the first entity.

2. A method as recited in claim 1, wherein the first action is a transactional action with the second entity.

3. A method as recited in claim 2, wherein the transactional action with the second entity includes the acquisition of a product or service by the first entity from the second entity.

4. A method as recited in claim 1, wherein at least one of the first and second entities is an individual, a company, a group of individuals or a charitable society.

5. A method as recited in claim 1, wherein the second action includes at least one of an environmental action, a charitable action and a third action towards a third entity.

6. A method as recited in claim 5, wherein the first action causes pollution; the second action resulting in at least partially offsetting the pollution.

7. A method as recited in claim 6, wherein said performing a second action includes quantifying the pollution.

8. A method as recited in claim 6, wherein the at least partially offsetting of the pollution is achieved by adding a biomass in a selected area.

9. A method as recited in claim 8, wherein the biomass includes trees.

10. A method as recited in claim 1, further comprising the second entity advertising the performing of a second action in response to the first action by the first entity.

11. A method as recited in claim 1, wherein said personalizing the second action includes associating the second action to at least one of the first and second entities and a third entities.

12. A method as recited in claim 11, wherein said personalizing the second action includes publicizing the second action with reference to the at least one of the first and second entities and a third entities.

13. A method as recited in claim 12, wherein said publicizing the second action includes visually representing the second action or a consequence thereof.

14. A method as recited in claim 1, wherein the second entity personalizing the second action in response to a plurality of first actions by the first entity.

15. A method as recited in claim 1, wherein the action performed by the second entity includes a plurality of second actions.

16. A system to promote a first action by a first entity comprising:
first means to allow a second entity to acknowledge the first action after the first action is performed the first entity; and
second means to personalize a second action performed by the second entity in response to the first action.

17. A system as recited in claim 16, wherein at least one of the first and second means includes at least one computer server.

18. A system as recited in claim 17, wherein the second means to personalize a second action by the second entity includes a web server which hosts a web site including at least one web page including information relative to the second action.

19. A system as recited in claim 18, wherein the second action is personalized by associating the second action to at least one selected entity among the first and second entities and a third entity and by advertising the selected entity on the web site in association with the second action.

20. A system as recited in claim 17, wherein the at least one computer server is configured to receive data indicative of the first action being performed by the first entity.

21. A system as recited in claim 17, wherein the at least one computer server is configured to manage and allow access to data indicative of the second action performed by the second entity.

22. A system as recited in claim 17, wherein the at least one computer server is configured to manage and allow access to data indicative of at least one of the first and second entities.

23. A system as recited in claim 17, wherein the at least one computer server is configured to manage and allow access to promotional information about the second entity performing a second action is response to the first action and about the second entity personalizing the second action.

24. A system as recited in claim 23, wherein the second action includes the use of at least one element at a location.

25. A system as recited in claim 24, wherein the data indicative of the second action includes coordinates of the location.

26. A system as recited in claim 25, further comprising referencing tools associated to the at least one element for providing the coordinates of the location.

27. A system as recited in claim 24, wherein the data indicative of the second action includes information about the at least one element.

28. A system as recited in claim 16, wherein at least one of the first and second means includes at least one application server; the system further comprising a communication server coupled to the at least one application server.

29. A system as recited in claim 28, wherein the first entity includes a plurality of first entities; the first action includes a plurality of first actions, each performed by at least one of the first entities; the at least one application server and the communication server are configured to create and manage a community including the plurality of first entities by allowing distributed communications among and to the plurality of first entities.

30. A system as recited in claim 29, wherein the communication server is programmed with a customer relationship management (CRM) service.

31. A system as recited in claim 29, wherein the communication server is programmed so that the distributed communications are allowed in different formats, each of the different formats being readable by one of a plurality of communication devices, each operating on a different platform.

32. A system as recited in claim 16, wherein the second means to personalize a second action performed by the second entity includes at least one of an electronic media and a written media.
